(19) United States
(12) Patent Application Publication
(10) Pub. No.: US 2014/0251863 A1
(43) Pub. Date: Sep. 11, 2014

(54) PUSH BUTTON PILL CONTAINER WITH REGISTER AND METHODS

(71) Applicant: APOTHECARY PRODUCTS, INC., (US)

(72) Inventors: Robert N. Priebe, Bloomington, MN (US); Terrance O. Noble, Burnsville, MN (US)

(73) Assignee: APOTHECARY PRODUCTS, INC., Burnsville, MN (US)

(21) Appl. No.: 13/790,303

(22) Filed: Mar. 8, 2013

(51) Int. Cl. A61J 1/03; A61J 7/04

(52) U.S. Cl. CPC A61J 1/03; A61J 7/04
USPC 206/534; 206/538

(57) ABSTRACT

A multiple compartment container includes a base having a plurality of compartments, each having a moveable lid. A cover is slidably attached to the base and spaced from the bottom wall of the base to define a register holder therebetween. The cover can slidably move relative to the base and along the bottom wall to provide access to the register holder. A method of using a multiple compartment container includes sliding the cover to move relative to the base and along the bottom wall to provide access to the register holder.

### TECHNICAL FIELD

This disclosure relates to a multiple compartment pill container. In particular, this disclosure relates to a multiple compartment bill container having push buttons and a register, and methods of use.

### BACKGROUND

For persons who need to take medicine regularly, the need for a pill container that can be easily carried is important. A pill container that is easy to use, has sufficient capacity for the person's needs, and which can be conveniently carried by the user increases the likelihood that the user will take the correct medication at the correct time.

Some pill containers are difficult to use for people with arthritis, poor dexterity, poor eyesight or weak muscles. In addition, some people have more complex medications schedules, and they may not remember which medications need to be taken at what frequency.

Improvements in pill containers to address these shortcomings are desirable.

### SUMMARY

In one aspect, a multiple compartment container is provided. The multiple compartment container includes a base having a plurality of compartments, with each compartment having an access opening providing access to an interior volume. The base has a front wall, a rear wall opposite of the front wall, a first side wall extending between the front wall and rear wall, a second side wall extending between the front wall and rear wall, and a bottom wall opposite of the access opening. A plurality of lids is provided. Each lid has an attached end being moveably attached to the rear wall and a free end moveable to and away from the front wall such that the lid selectively covers and uncovers the access opening of a respective compartment. A cover is slidably attached to the base and is adjacent to and spaced from the bottom wall to define a register holder therebetween. The cover is constructed and arranged to slidably move relative to the base and along the bottom wall to provide access to the register holder.

In another aspect, a method of using a multiple compartment container is provided. The method includes providing a container including a base having a plurality of compartments, with each compartment having an access opening providing access to an interior volume. The base has a front wall, a rear wall opposite of the front wall, a first side wall extending between the front wall and rear wall, a second side wall extending between the front wall and rear wall, and a bottom wall opposite of the access opening. A plurality of lids is provided. Each lid has an attached end that is moveably attached to the rear wall and a free end moveable to and away from the front wall such that the lid selectively covers and uncovers the access opening of a respective compartment. A cover is slidably attached to the base and is adjacent to and spaced from the bottom wall to define a register holder therebetween. The method includes sliding the cover to move relative to the base and along the bottom wall to provide access to the register holder.

A variety of examples of desirable product features or methods are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are explanatory only, and are not restrictive of the claimed invention.

### BRIEF DESCRIPTION OF THE DRAWINGS

FIG. 1 is a perspective view of a first embodiment of a multiple compartment container constructed according to principles of this disclosure;

FIG. 2 is a perspective view of the container of FIG. 1, and showing the lids in an open position and a cover slid from the base;

FIG. 3 is an exploded, perspective view of the container of FIG. 1;

FIG. 4 is another exploded, perspective view of the container of FIG. 1;

FIG. 5 is a perspective view of the container of FIG. 1, viewing the bottom of the container;

FIG. 6 is a bottom view of the container of FIG. 1 with the lids in the open position;

FIG. 7 is a cross-sectional view of the container taken along the line 7-7 of FIG. 6;

FIG. 8 is a top view of the container of FIG. 1;

FIG. 9 is a cross-sectional view of the container of FIG. 1, the cross-section being taken along the line 9-9 of FIG. 8;

FIG. 10 is a cross-sectional view of the container of FIG. 1, the cross-section being taken along the line 10-10 of FIG. 8;

FIG. 11 is a bottom view of the container of FIG. 1, showing the cover slid relative to the base and showing the medication register;

FIG. 12 is a top view of one example medication register useable with the container of FIG. 1;

FIG. 13 is a cross-sectional view of the container of FIG. 1, similar to the cross-section shown in FIG. 10, but with the push button tabs removed to show other structures;

FIG. 14 is a perspective view of a pill holder shown in FIGS. 9 and 11;

FIG. 15 is a perspective view of a tab that is used as part of a push button assembly to open the lids of the container of FIG. 1;

FIG. 16 is a bottom view of the tab of FIG. 15;

FIG. 17 is a top view of the tab of FIG. 15;

FIG. 18 is a side view of the tab of FIG. 15; and

FIG. 19 is a top view of the container of FIG. 1, with all of the lids in an open position.

### DETAILED DESCRIPTION

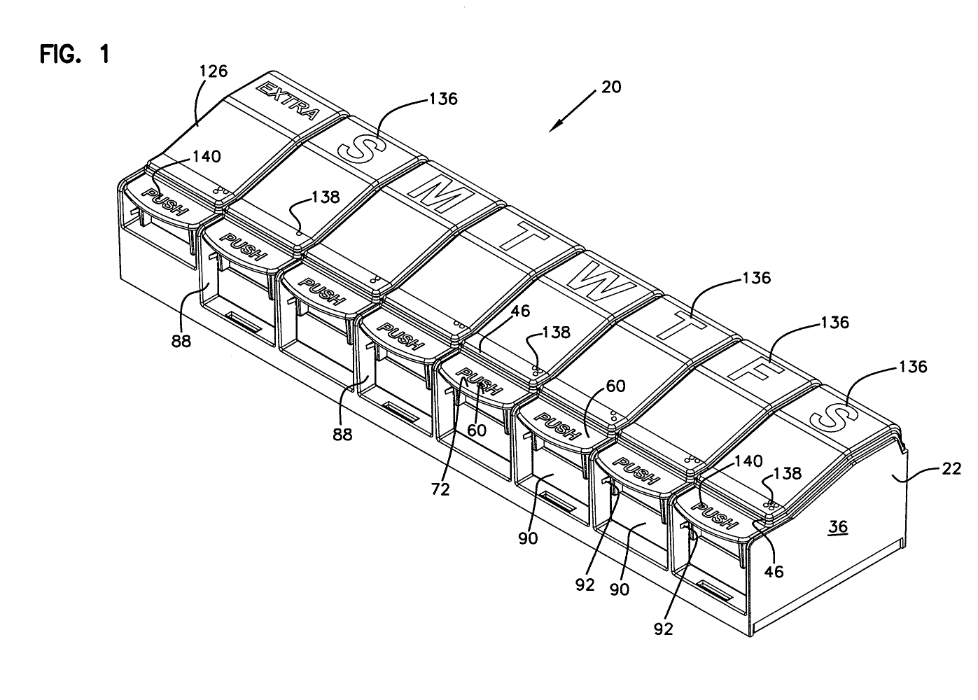

FIG. 1 depicts one example embodiment of a multiple compartment container generally at reference 20. In general, the container 20 is useable to hold or store items, such as pills. While pills will be the example discussed, it should be understood that pills can mean vitamins, or it can also mean non-medicinal items. The pills, or whatever items are used, are stored within the container 20 and can be selectively accessed for later use.

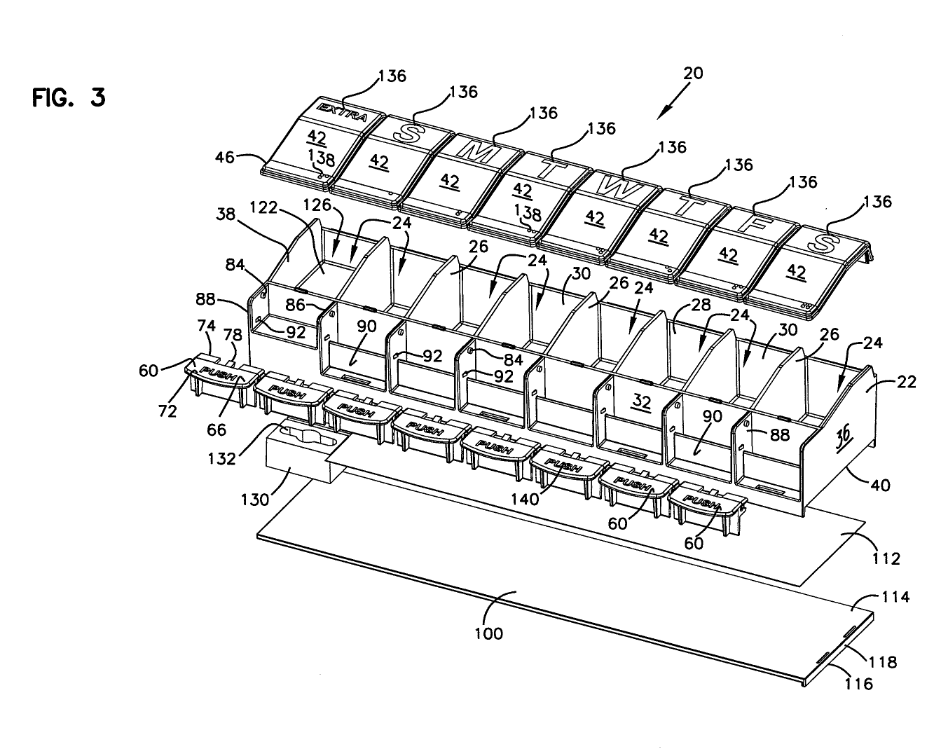

The pill container 20, in this embodiment, includes a base 22 defining at least one compartment 24. In the illustrated embodiment, at least one compartment 24 includes a plurality of compartments 24. The compartments 24 are separated from each other by a plurality of dividers 26 (see FIG. 3 within the base 22).

The compartments 24 each has an access opening 28 providing access to a pill-holder interior volume 30.

The plurality of compartments 24 can include any number of compartments 24. In the particular embodiment illustrated, the base consists of eight compartments 24. In this manner, each of the compartments 24 can represent one of the days of the week, with an extra compartment 24 being provided to store extra pills. Other embodiments can include not more than seven compartments, or may include more than eight compartments. In addition, a single compartment 24 can utilize principles of this disclosure as well.

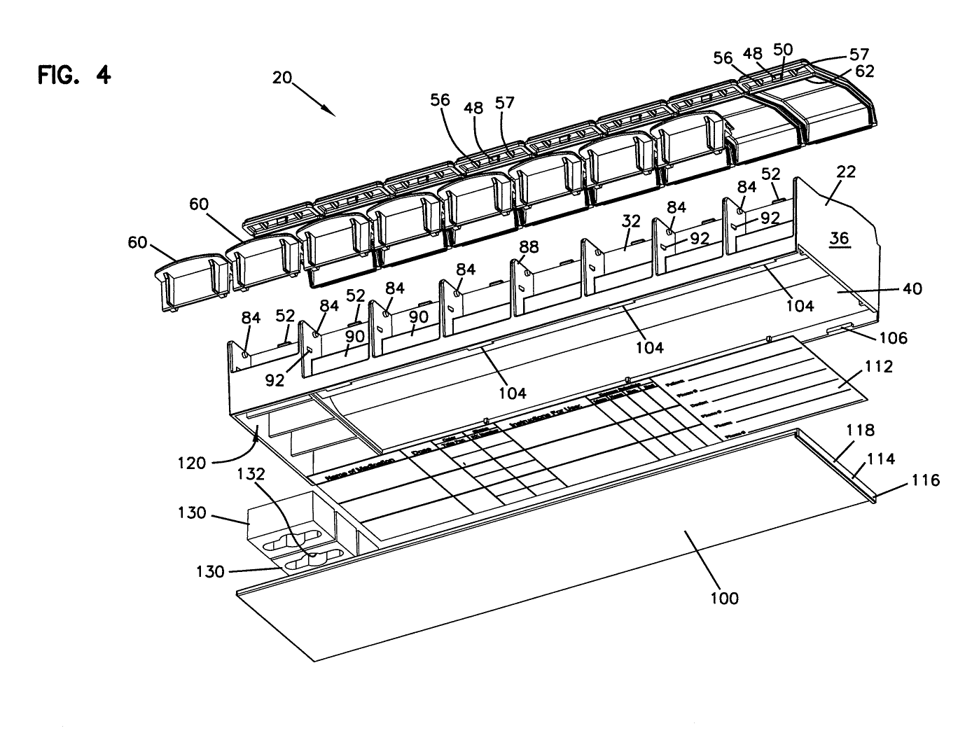

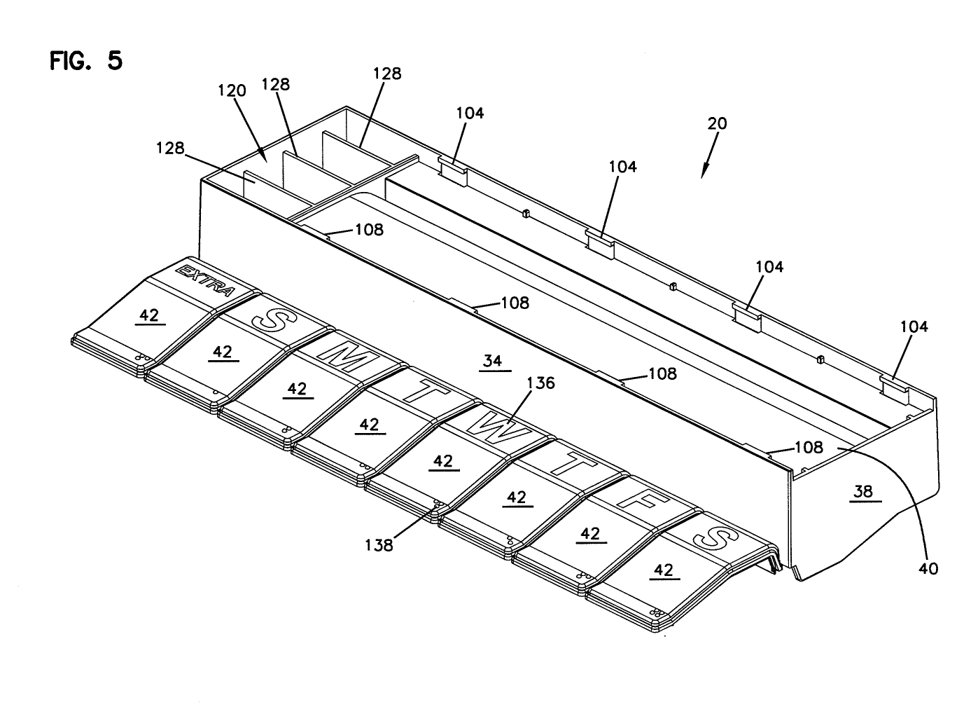

The base 22 includes a front wall 32 (FIG. 3), a rear wall 34 (FIG. 5) opposite of the front wall 32, a first side wall 36 extending between the front wall 32 and rear wall 34, a second side wall 38 (FIGS. 3-6) extending between the front wall 32 and rear wall 34, and a bottom wall 40 (FIGS. 4 and 5) opposite of the access opening 28. The bottom wall 40 also extends between the front wall 32 and rear wall 34 and between the first side wall 36 and second side wall 38.

In accordance with principles of this disclosure, the multiple compartment container 20 includes at least one lid 42. When multiple compartments 24 are used, there will be a plurality of lids 42, one lid per compartment 24.

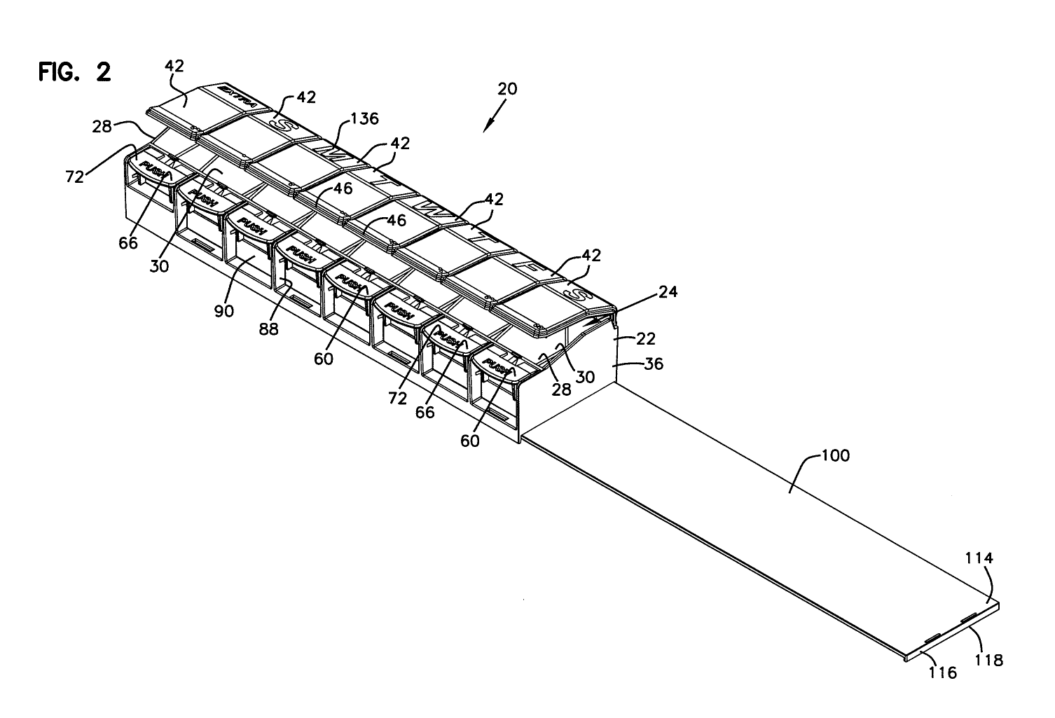

Each lid 42 is moveable between a covering position (FIG. 1) and an open position (FIG. 2). The covering position is a position in which a respective one of the lids 42 covers the access opening 28 of a respective one of the compartments 24. In this way, access to the pill holder interior volume 30 is also blocked. The open position is a position in which a respective one of the lids 42 is spaced away from a respective one of the compartments 24 and away from the access opening 28 to allow access to the interior volume 30.

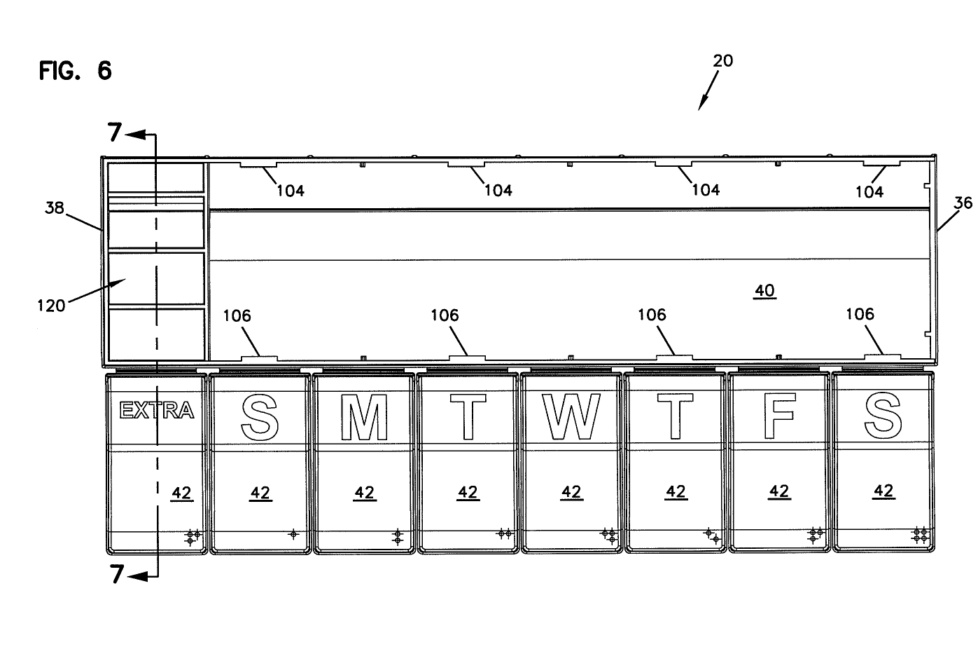

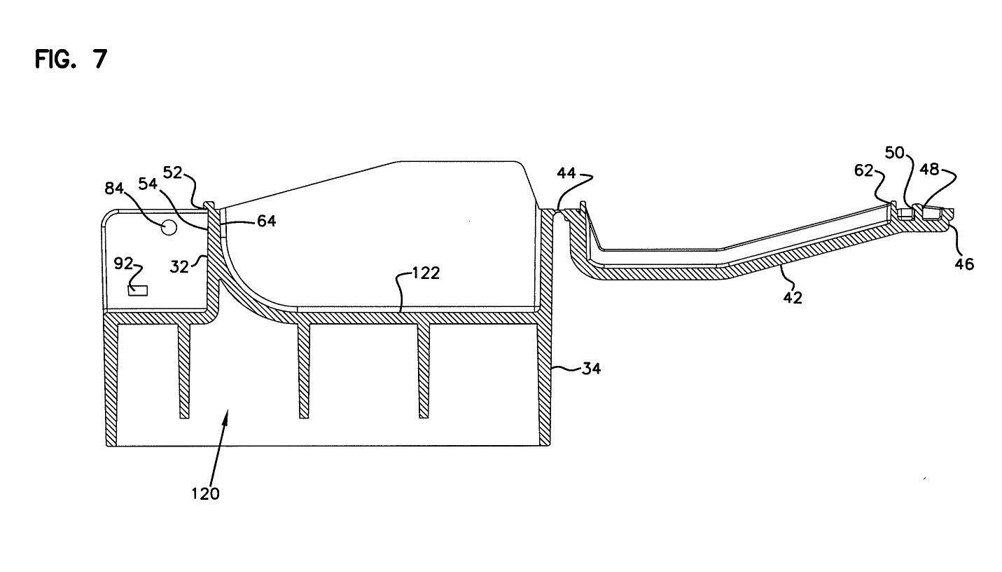

In this embodiment, each lid 42 has an attached end 44 (FIGS. 6 and 7) and an opposite free end 46 (FIGS. 6 and 7). The attached end 44 is moveably attached to the rear wall 34. This moveable attachment can be through a variety of means, such as by a living hinge. The free end 46 is moveable to and away from the front wall 32 such that the lid 42 selectively covers and uncovers the access opening 28 of a respective compartment.

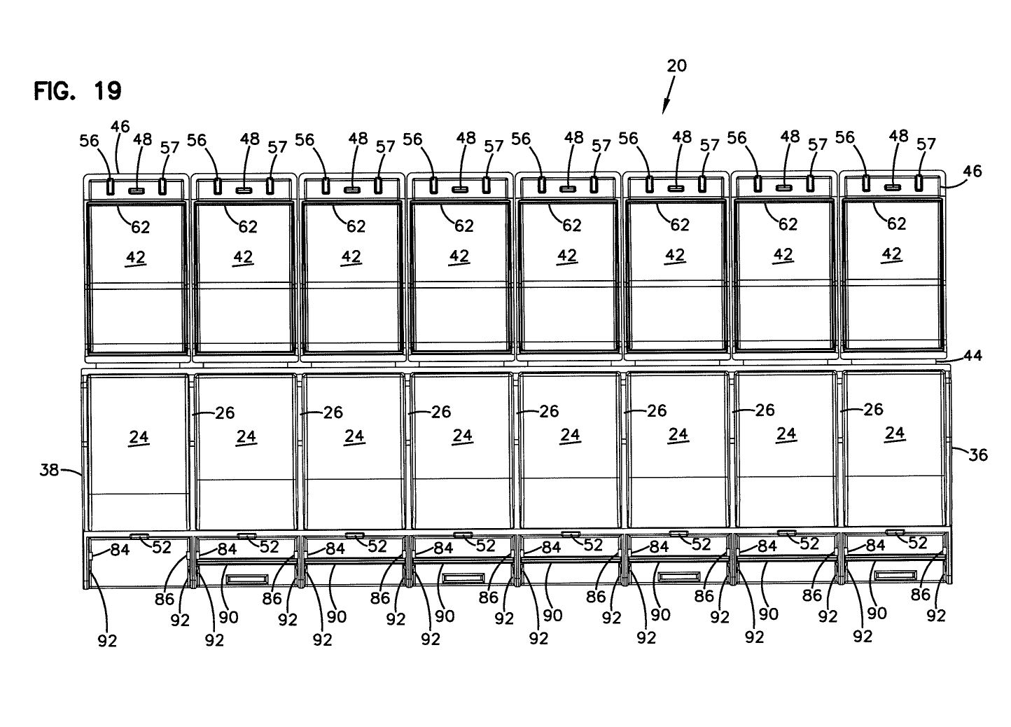

Each of the lids 42 can be selectively snapped into a closed engagement with the base 22. Many different implementations are possible. In this embodiment, the free end 46 has a locking arm 48 (FIGS. 4 and 19) extending from an inside surface of the lids 42 and toward a direction of the compartment interior volume 30. The locking arm 48 includes a lid catch 50 (FIG. 7), which engages in a snap fit with a base catch 52 (FIG. 7) extending from an outside surface 54 of the front wall 32.

In this embodiment, the free end 46 of each lid 42 can also include first and second standoffs 56, 57 (FIGS. 4 and 19). The locking arm 48 is centered between the first and second standoffs 56, 57. The standoffs 56, 57 are configured to extend downwardly from the lid 42 and rest on a respective tab 60. The tabs 60 are described further below.

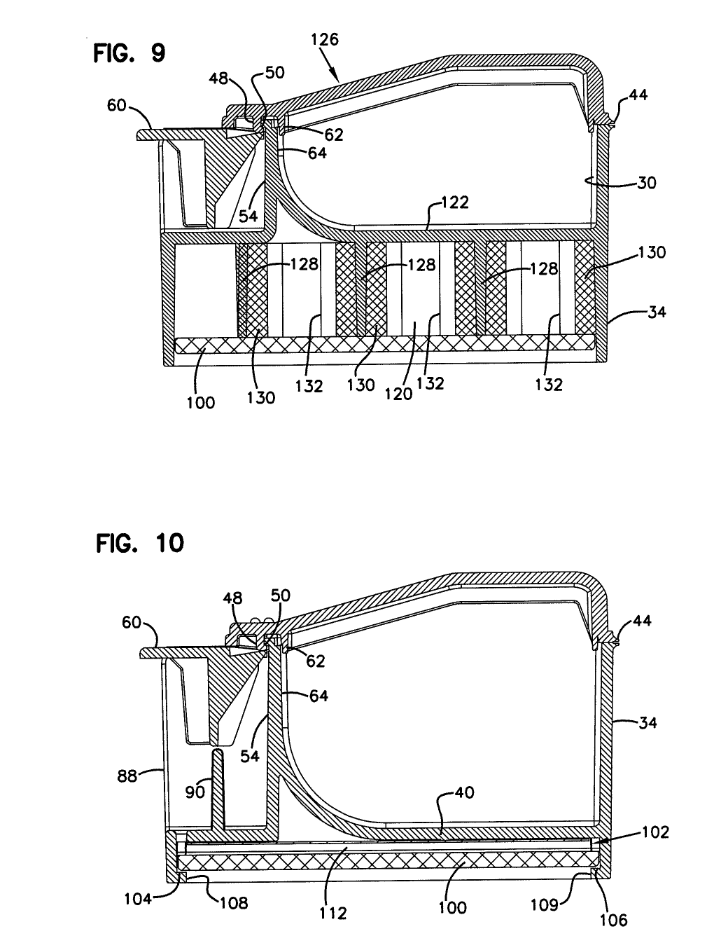

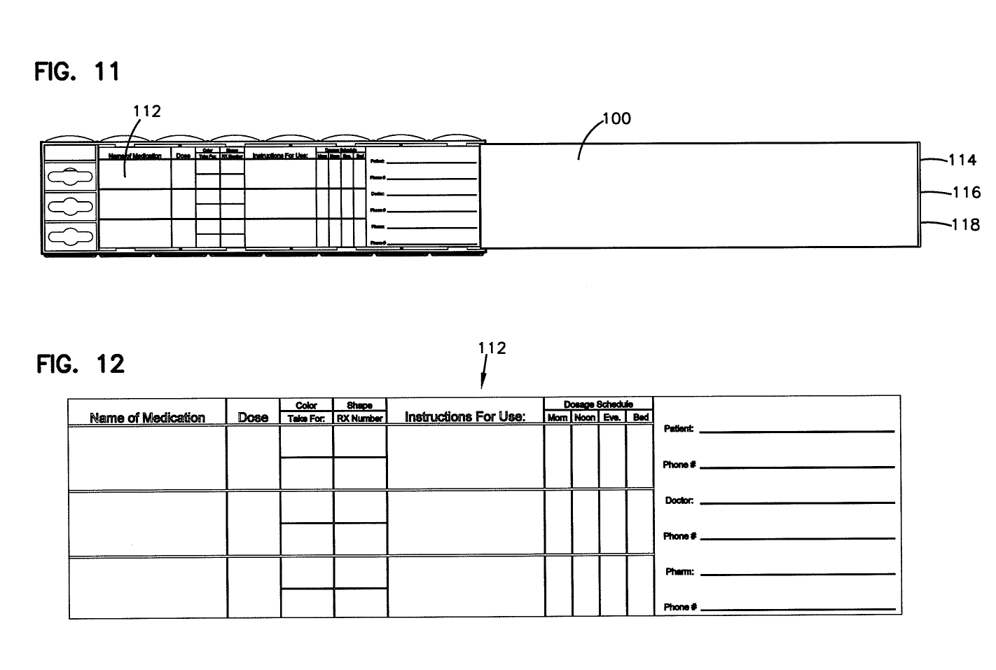

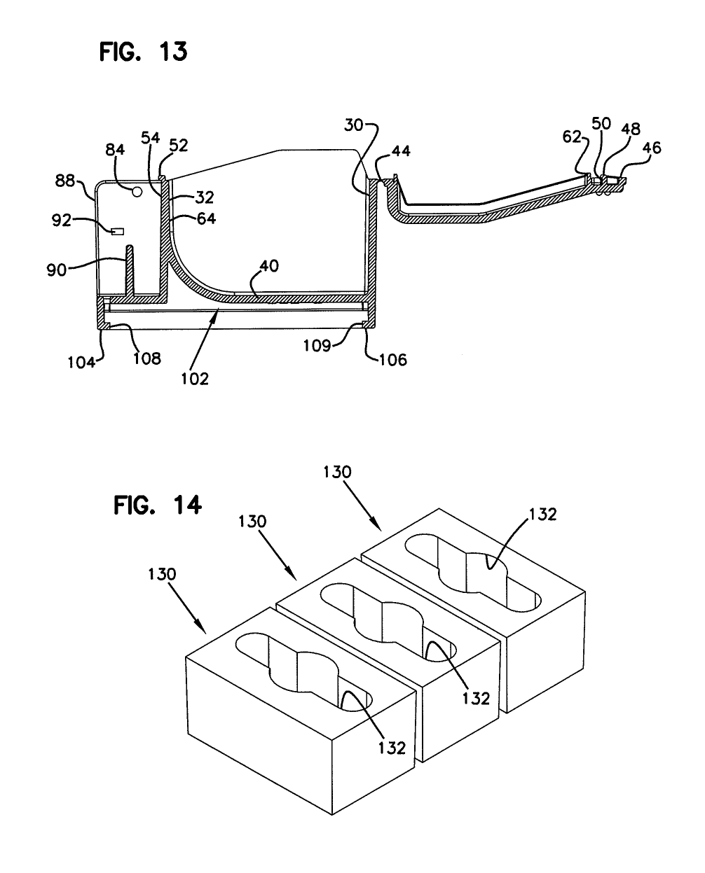

Each of the lids 42 includes a lip member 62. The lip member 62 engages an inside surface 64 (FIGS. 9 and 10) of the front wall 32 of the base 22. In this example, the engagement of the lip member 62 and the inside surface 64 of the front wall 32 contact each other and substantially seals the free end 46 of the lid 42 with the front wall 32 of the base 22.

As mentioned above, the container 20 includes at least one tab 60. In the embodiment depicted, there are a plurality of tabs 60. In the example embodiment shown, there is one tab 60 for each compartment 24. In other embodiments, there can be different types of arrangements for opening and closing the compartments 24, so each compartment 24 would not necessarily need a tab 60.

In the example shown, each of the tabs 60 is pivotably connected to the base 22 at a location opposite the front wall 32 from the interior volume 30. Each tab 60 is constructed and arranged such that depressing the tab 60 causes a respective lid 42 to disengage from the snap connection with the front wall 32 of the base 22 and thereby position the lid 42 to uncover the access opening 28.

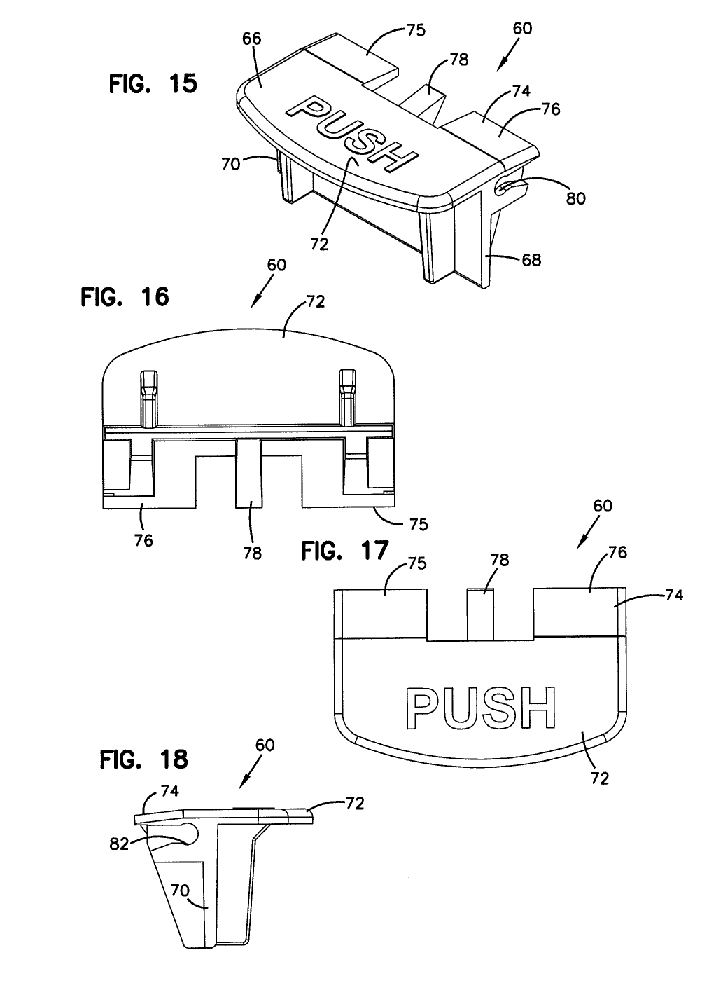

FIGS. 15-18 illustrate tab 60 in greater detail. In the depicted embodiment, the tab 60 includes the top surface 66, a first end portion 68, and a second end portion 70. The top surface 66 includes a front portion 72 and a back portion 74. The back portion 74 is configured to pivot upwards when the front portion 72 is moved downwards. The back portion 74 is configured to raise the free end 46 of the lid 42 and release the locking arm 48 from the base catch 52 when the front portion 72 is depressed.

In the example embodiment depicted, the back portion 74 includes first and second side back members 75, 76 separated by a center back member 78. The center back member 78 is configured to contact the locking arm 48 and move the locking arm 48 from the engaged position (in which the lid catch 50 is engaged with the base catch 52) to a disengaged position (in which the lid catch 50 and base catch 52 are nonengaged). The first side back member 75 and second side back member 76 are configured to contact the first and second standoffs 56, 57 and move them upwards when the front portion 72 of the tab 60 is depressed. This engagement between the side back members 75, 76 and the standoffs 56, 57 further assist with disengaging the lid catch 50 from the base catch 52.

In reference now to FIGS. 15 and 18, in the depicted embodiment, the first end portion 68 (FIG. 15) and the second end portion 70 (FIG. 18) each includes a recess 80, 82. Each recess 80, 82 is configured to engage a pivot protrusion 84, 86 (FIGS. 3 and 19) on a front end portion 88 of the base 22. The front end portion 88 is the end of the base 22 that is closest to the free end 46 of the lids 42. As can be seen in FIG. 3, the front end portion 88 can be generally continuous with either first side wall 36, second side wall 38, or divider 26. The front end portion 88 is generally perpendicular to the front wall 32. The front end portion 88 is on a side of the front wall 32 that is opposite from the interior volume 30.

The recesses 80, 82 are configured to slide into and snap into engagement with the pivot protrusions 82, 80.

In the example depicted, the front end portion 88 of the base 22 includes a vertical guard wall 90 (FIGS. 3 and 4) extending vertically from the bottom wall 40 a part of a distance along the front end portions 88. The vertical guard wall 90 helps to prevent the tab 60 from being inadvertently actuated.

The front end portion 88 includes protrusions 92 (FIG. 3) extending therefrom. The protrusions 92 act as rotational stops to limit the rotation of the tab 60 when the lid 42 is locked in place with the base 22. When the lid 42 is disengaged from the base 22, engagement between the center back member 78 and base catch 52 prevent over-rotation.

One example of a push tab assembly, which can be utilized in this embodiment, is described in U.S. Pat. No. 7,624,890, incorporated by reference in its entirety.

In accordance with principles of this disclosure, the multiple compartment container 20 includes a cover 100 (FIGS. 2-4). The cover 100 is slidably attached to the base 22 and is adjacent to and spaced from the bottom wall 40 to define a register holder 102 (FIG. 10) therebetween. The cover 100 is constructed and arranged to slidably move relative to the base 22 and along the bottom wall 40 to provide access to the register holder 102. In the example shown in FIGS. 2 and 11, the cover 100 is slidable in a direction toward and against the first and second side walls 36, 38.

Many different implementations are possible. In the example shown in FIG. 10, the base 22 defines first and second slide rails 104, 106 (FIG. 10) along the front end portion 88 of the base 22 and along the rear wall 34 of the base 22. The slide rails 104, 106 each includes a lip 108, 109, which hold the cover 100 in place. As can be appreciated by reviewing FIGS. 2, 10, and 11, the cover 100 is slidable within the slide rails 104, 106 relative to the base 22 to allow access to the register holder 102. The register holder 102 is for containing and holding a removable card 112. The rails 104, 106 can be continuous along the front end portion 88 and rear wall 34, but in the embodiment shown, the rails 104, 106 are discontinuous in the form of four discrete sections of rails 104, 106 (see FIGS. 5 and 6).

In preferred embodiments, the cover 100 is made from a transparent material, such that any information on the card 112 is visible through the cover 100.

FIG. 11 illustrates one example card 112. The card 112 can be made from paper or cardboard, and it can contain any type of information. In the example embodiment shown, the card 112 includes medical information with fields for the name of the medication, the dosage, the color and shape, the medical condition to take the medication, the prescription number, instructions for use, dosage schedule, and information on the patient name, phone number, doctor name, phone number, pharmacy name, and phone number. Information can be written on the card 112, and then placed in the register holder 102, when the cover 100 is removed. After the card 112 is in the register holder 102, the cover 100 can be slid into the slide rails 104, 106 at the first side wall 36 and then slid in place until the cover 100 is fully within the base 22. In some embodiments, the card 112 can be slid into the register holder after the cover 100 has been oriented fully within the base 22.

In this manner, the container 20 can include medication in the compartments 24 and the user can view the information on the registration card 112 by merely turning the container 20 over and viewing the information on the card 112 through the transparent cover 100.

If there is a change in medication or dosage or anything else, the card 112 can be accessed by sliding the cover 100 within the slide rails 104, 106 to provide access to the card 112. The information can be changed on the card 112, or a new card 112 can be provided within the register holder 102. Then, the cover 100 can be again slid in place to cover the card 112.

As can be seen in FIGS. 2-4, at least one of the ends 114 of the cover 100 includes a handle 116. The handle 116 is in the form of a flange 118 angled generally perpendicular to a remaining portion of the cover 100. The flange 118 provides the user with handle 116 to grasp with their fingers in order to move the cover 100 and slide it relative to the base 22.

In accordance with principles of this disclosure, the bottom wall 40 is recessed along at least one of the compartments 24 in the base 22 to provide a second interior volume 120 (FIGS. 4-7) between the recessed bottom wall 122 (FIGS. 7 and 9) and the slidable cover 100. The second interior volume 120 is accessible by sliding the cover 100 to expose the second interior volume 120.

In the example shown in FIGS. 3, 7, and 9, the compartment 126, in this embodiment located adjacent to the second side wall 38, but of course could be anywhere along the base 22, includes the recessed bottom wall 122. This results in the interior volume 30 of the compartment 126 as being more shallow than the other interior volumes 30. On an opposite side of the recessed bottom wall 122, the second interior volume 120 results.

The second interior volume 120, can be used for a variety of functions. In the example shown, the second interior volume 120 includes a plurality of partitions 128, and in the example shown, there are three partitions 128. Within the second interior volume 120 there can be a flexible pill holder 130 therewithin. The pill holder 130 can be used to hold a pill therein against gravity.

An example pill holder 130 is shown in FIG. 14. In this embodiment, the pill holder 130 is made from a flexible material, such as foam, and includes an opening 132 there within. The pill holder 130 is flexible enough such that the pill can be placed within the opening 132, and the flexibility of the material of the pill holder 130 will accommodate the pill within the opening 132 and hold it in place against gravity. FIG. 14 shows three pill holders 130, which can be placed within the second interior volume 120 between each of the partitions 128.

It should be appreciated that extra pills can be held within the openings 132 of the pill holders 130 within the second interior volume 120. These extra pills would be accessible by sliding the cover 100 relative to the base 22 to expose access to the second interior volume 120.

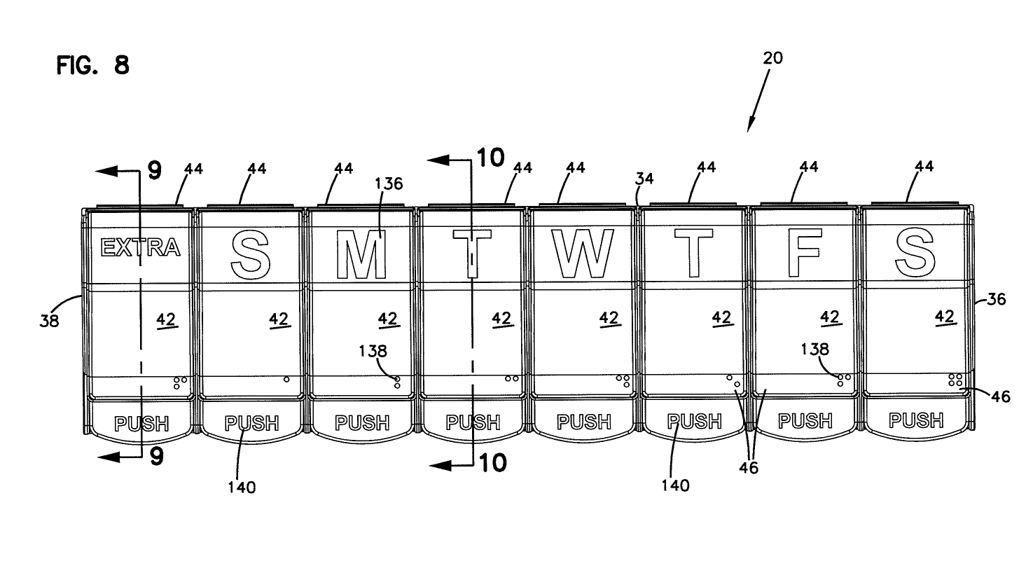

From a review of FIGS. 1 and 8, it can be seen how, in this embodiment, the container 20 includes written indicia 136 on each of the lids 42. The indicia 136 can say anything for the purposes of the container 20. In the embodiment depicted, the indicia 136 include the first letter of each day of the week thereon, so that the container 20 can include daily medication organized by day and on a weekly basis. On each of the lids 42 there can also be braille 138 to assist the visually impaired. In the example shown in the FIGS., there are eight compartments 24, so after accounting for each of the days of the week, there is an extra compartment, previously identified at reference 126. The extra compartment 126 can include extra pills. In FIG. 1, the indicia 136 for the extra compartment 126 are labeled as “extra.” Of course, many variations in the indicia 136 are possible.

Each of the tabs 60 includes the word “push” at 140 to provide instructions on how to operate the container 20 in order to provide access to the interior volume 30. The instruction at 140 provides the user with information that to move the lid 42 from the locked and closed position to the open position uncovering the access opening 28, the tab 60 should be pushed. Of course, other variations on the instruction 140 are possible.

A method of using a multiple compartment container can be implemented utilizing the principles as disclosed herein. First, a container, such as container 20 is provided. The container 20 will include cover 100 slidably attached to the base 22 and being adjacent to and spaced from the bottom wall 40 to define the register holder 102 therebetween. The method includes sliding the cover 100 to move relative to the base 22 and along the bottom wall 40 to provide access to the register holder 102.

The step of sliding can include sliding the cover 100 in a direction toward and against the first and second side walls 36.

The method can include depressing a front portion 72 of one of the tabs 60 to cause the rear portion 74 of the tab 60 to contact a respective one of the lids 42 and disengage the free end 46 of the respective lid 42 from the front wall 32 of the base 22 and thereby position the lid 42 to uncover the respective access opening 28.

The method can include accessing the second interior volume 120 by sliding the cover 100. The second interior volume 120 is between the recessed bottom wall 122 and the slidable cover 100.

The above includes example principles of this disclosure. Many embodiments can be made applying these principles.

What is claimed is:

1. A multiple compartment container comprising:
(a) a base having a plurality of compartments, each compartment having an access opening providing access to an interior volume;
(i) the base having a front wall, a rear wall opposite of the front wall, a first side wall extending between the front wall and rear wall, a second side wall extending between the front wall and rear wall, and a bottom wall opposite of the access opening;
(b) a plurality of lids; each lid having an attached end being movably attached to the rear wall, and a free end movable to and away from the front wall such that the lid selectively covers and uncovers the access opening of a respective compartment; and
(c) a cover slidably attached to the base and being adjacent to and spaced from the bottom wall to define a register holder therebetween; the cover being constructed and arranged to slidably move relative to the base and along the bottom wall to provide access to the register holder.

2. A container according to claim 1 wherein:
(a) the cover is constructed and arranged to slide in a direction toward and against the first and second side walls.

3. A container according to claim 1 further comprising:
(a) a removable card with information oriented in the register holder.

4. A container according to claim 1 wherein:
(a) each lid includes a lid catch at the free end releasably engaging a base catch on the front wall.

5. A container according to claim 4 further comprising:
(a) a plurality of tabs pivotably connected to the base at a location opposite the front wall from the interior volume, wherein each tab is constructed and arranged such that depressing a front portion of the tab causes a rear portion of the tab to contact a respective lid and disengage the free end of the lid from the front wall of the base and thereby position the lid to uncover the access opening.

6. A container according to claim 1 wherein:
(a) the bottom wall is recessed along at least one of the compartments in the base to provide a second interior volume between the recessed bottom wall and the slidable cover; the second interior volume being accessible by sliding the cover to expose the second interior volume.

7. A container according to claim 6 wherein:
(a) the second interior volume includes a flexible pill holder to hold a pill therein against gravity.

8. A container according to claim 6 wherein:
(a) the base consists of 8 compartments.

9. A method of using a multiple compartment container, the method comprising:
(a) providing a container including a base having a plurality of compartments, each compartment having an access opening providing access to an interior volume;
(i) the base having a front wall, a rear wall opposite of the front wall, a first side wall extending between the front wall and rear wall, a second side wall extending between the front wall and rear wall, and a bottom wall opposite of the access opening;
(ii) a plurality of lids; each lid having an attached end being movably attached to the rear wall, and a free end movable to and away from the front wall such that the lid selectively covers and uncovers the access opening of a respective compartment; and
(iii) a cover slidably attached to the base and being adjacent to and spaced from the bottom wall to define a register holder therebetween;
(b) sliding the cover to move relative to the base and along the bottom wall to provide access to the register holder.

10. A method according to claim 9 further comprising:
(a) placing a removable card with information in the register holder.

11. A method according to claim 9 wherein:
(a) the step of sliding includes sliding the cover in a direction toward and against the first and second side walls.

12. A method according to claim 9 wherein:
(a) each lid includes a lid catch at the free end releasably engaging a base catch on the front wall;
(b) the container includes a plurality of tabs pivotably connected to the base at a location opposite the front wall from the interior volume; and
(c) the method further comprises depressing a front portion of one of the tabs to cause a rear portion of the tab to contact a respective lid and disengage the free end of the respective lid from the front wall of the base and thereby position the respective lid to uncover the respective access opening.

13. A method according to claim 9 wherein:
(a) the bottom wall is recessed along at least one of the compartments in the base to provide a second interior volume between the recessed bottom wall and the slidable cover; and
(b) the method further comprises accessing the second interior volume by sliding the cover.
